(19) United States
(12) Patent Application Publication
(10) Pub. No.: US 2026/0046599 A1
(43) Pub. Date: Feb. 12, 2026

(54) USER EQUIPMENT (UE) ROUTING SELECTION POLICY (URSP) RULES FOR A ROAMING UE

(71) Applicant: Apple Inc., Cupertino, CA (US)

(72) Inventors: Zhibin Wu, Los Altos, CA (US); Peng Cheng, Beijing (CN); Vivek G. Gupta, San Jose, CA (US); Sudeep Manithara Vamanan, Munich (DE); Behrouz Aghili, San Diego, CA (US); Haijing Hu, Los Gatos, CA (US)

(73) Assignee: Apple Inc., Cupertino, CA (US)

(21) Appl. No.: 19/101,003

(22) PCT Filed: Nov. 2, 2022
(86) PCT No.: PCT/CN2022/129301

§ 371 Date: Feb. 4, 2025

(30) Foreign Application Priority Data
Aug. 8, 2022 (WO) PCT/CN2022/110925

(51) Int. Cl. H04W 8/00; H04W 76/14; H04W 92/18

(52) U.S. Cl. CPC H04W 8/005; H04W 76/14; H04W 92/18

(57) ABSTRACT

The present application relates to improving a roaming service. In an example, a method includes a remote user equipment (UE) receiving a discovery message from a relay UE, the discovery message indicating an ability to serve as the relay UE for the first remote UE to reach a second remote UE. The remote UE can determine whether to select the relay UE to relay a message to the second remote UE based on the discovery message. The remote UE can select the relay UE to reach the second remote UE based on the determination.

### TECHNICAL FIELD

The present disclosure generally relates to wireless communication, and in particular, to user equipment (UE) routing selection policy (URSP) rules for a roaming UE.

### BACKGROUND

Cellular communications can be defined in various standards to enable communications between a user equipment and a cellular network. For example, a Fifth generation mobile network (5G) is a wireless standard that aims to improve upon data transmission speed, reliability, availability, and more.

### BRIEF DESCRIPTION OF THE DRAWINGS

FIG. 1 is a signaling diagram of a user equipment (UE) to Network (U2N) discovery process, according to one or more embodiments.

FIG. 2 is a signaling diagram of a U2N process, according to one or more embodiments.

FIG. 3 is a signaling diagram of a connectivity-based scheme for UE-to-UE (U2U) relay discovery, according to one or more embodiments.

FIG. 4 is a signaling diagram of a connectivity-based scheme for U2U relay discovery, according to one or more embodiments.

FIG. 5 is an illustration of rebroadcasting for an interest-based scheme, according to one or more embodiments.

FIG. 6 is a signaling diagram of a connectivity-based scheme for U2U relay discovery, according to one or more embodiments.

FIG. 7 is a signaling diagram of a connectivity-based scheme for U2U relay discovery, according to one or more embodiments.

FIG. 8 is a signaling diagram of a connectivity-based scheme for U2U relay discovery, according to one or more embodiments.

FIG. 9 is a signaling diagram of an interest-based scheme for U2U relay discovery, according to one or more embodiments.

FIG. 10 is a signaling diagram of an interest-based scheme for U2U relay discovery, according to one or more embodiments.

FIG. 11 is an illustration of a table of discovery message types, according to one or more embodiments.

FIG. 12 is an illustration of remote UE discovery messages, according to one or more embodiments.

FIG. 13 is an illustration of U2URelayconnectivity messages for layer 2 (L2) U2U relay discovery, according to one or more embodiments.

FIG. 14 is an illustration of U2Uinterestrelay messages and U2Uinterestresponse messages for L2 U2U relay discovery, according to one or more embodiments.

FIG. 15 is an illustration of remote UE representations for L2 U2U relay discovery, according to one or more embodiments.

FIG. 16 is a process flow for selecting a relay, according to one or more embodiments.

FIG. 17 is a process flow for selecting a relay, according to one or more embodiments.

FIG. 18 is a process flow for selecting a relay, according to one or more embodiments.

FIG. 19 illustrates receive components of a UE, according to one or more embodiments.

FIG. 20 illustrates a UE, according to one or more embodiments.

FIG. 21 illustrates a gNB, according to one or more embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

Embodiments of the present disclosure are described in connection with 5G networks. However, the embodiments are not limited as such and similarly apply to other types of communication networks including other types of cellular networks.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, and/or 6G. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted.” Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

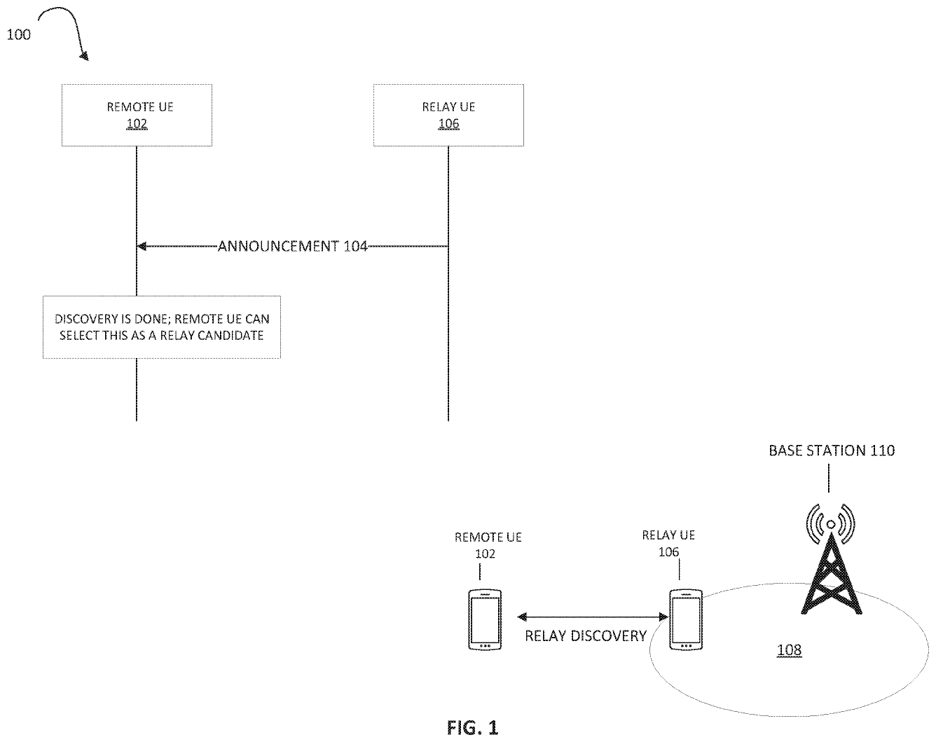

Relay discovery can be a process of identifying candidate relays to extend network coverage outside of a service area (e.g., a cell). FIG. 1 is a signaling diagram 100 of a user equipment (UE) to Network (U2N) discovery process, according to one or more embodiments (hereinafter referred to as “Model A.”). A remote UE 102 can receive an announcement 104 transmitted by a relay UE 106. The relay UE 106 can be camped on a cell 108. The announcement can indicate the relay UE's connectivity to the cell 108. A base station 110 can provide service to the cell 108. The remote UE 102 can be a UE that can use the relay UE 106 to access a wireless network, via the base station 110. The relay UE 106 can be a UE that can permit the remote UE 102 to access a wireless network, via the base station 110.

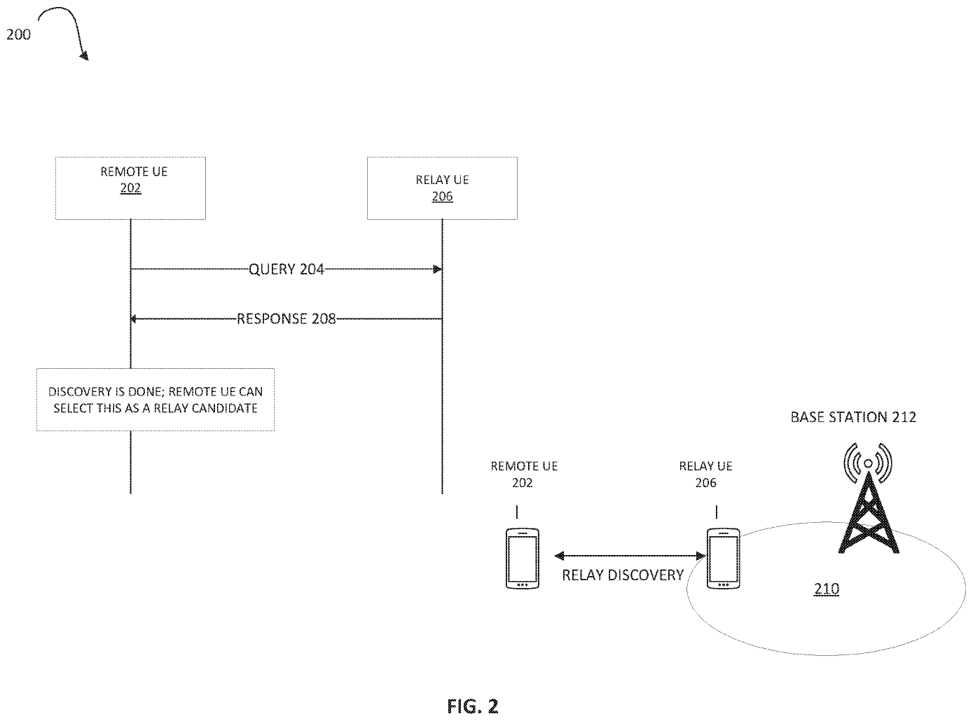

FIG. 2 is a signaling diagram 200 of a U2N process, according to one or more embodiments (hereinafter referred to as “Model B”). A remote UE 202 can transmit a query 204 to a relay UE 206 as whether there are U2N relays nearby for a relay service. The relay UE 206 can unicast a response 208 to the remote UE 202 about its relay service availability. In either model A or B, for the remote UE 102, 202, receiving the relay discovery message (e.g., announcement 104, response 208) is sufficient for determining whether the relay UE 106, 206 is a candidate or not. The relay UE 206 can be camped on a cell 210. A base station 212 can provide service to the cell 210. For FIGS. 1 and 2, the announcement 104, the query 204, and the response 208 can be messages used for discovery as described in 3GPP Technical Specification (TS) 24.554 v17.2.1 (2022-09-26).

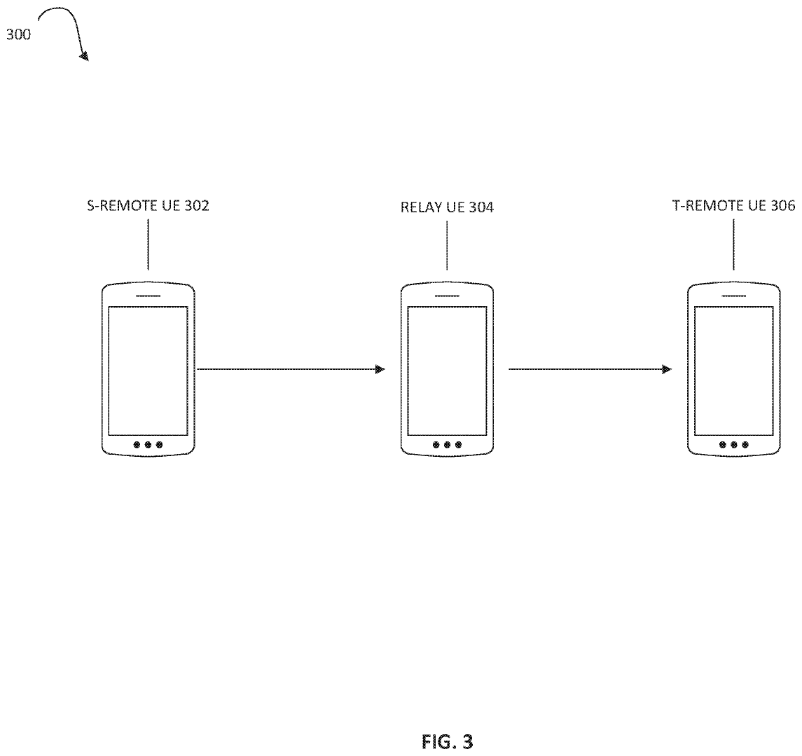

FIG. 3 is a signaling diagram 300 of a connectivity-based scheme for UE-to-UE (U2U) relay discovery, according to one or more embodiments. In a U2U relay discovery, the discovery scheme is more complex than a U2N discovery scheme. This is because the U2U relay discovery involves three nodes, Source Remote UE (S-Remote UE) 302, Relay UE 304, and Target Remote UE (T-Remote UE) 306, and two PC5 hops, while the U2N relay discovery only involves one PCS hop. For U2U relay discovery, the relay UE 304 can be a U2U relay UE and act as a bridge between the S-Remote UE 302 and the T-Remote UE 306. Therefore, the relay UE 304 can be responsible for monitoring activity from the S-Remote UE 302 and the T-Remote UE 306. Also, the relay UE, by default, has no “useful”information to broadcast until it discovers a remote UE first.

The above-described relay discovery model A and model B by themselves become too simplistic to model the behaviors of the S-Remote UE 302, the relay UE 304 and the T-Remote UE 306 in the U2U relay discovery scheme. Regarding what is the key information needs to be conveyed in the U2U relay discovery process, it can be obvious that first desired information is “U2U connectivity,” which means the S-Remote UE 302 and T-Remote UE 306 can be connected via relay UE 304. Note that this U2U connectivity information may only include one remote UE (S-Remote UE 302 or T-Remote UE 306), because when this message is received by the other remote UE in its PC5 interface, then the full connectivity (S-Remote UE 302 to Relay UE 304 to T-Remote UE 306) can be recognized by the receiving remote UE.

However, this information itself may not be sufficient to trigger relay selection because a remote UE may not always be interested in communicating with another remote UE in the first place. In U2U relay use cases, all remote UEs cannot be assumed always have mutual “interests” to talk to each other. In many cases, the interest is unilateral (e.g., from S-Remote UE 302 to T-Remote UE 306), and the peer remote UE may not share the same interest at all. For example, when such a U2U “connectivity” discovery message is received by T-Remote UE 306, it may disregard it because it has no particular interest in communicating with the S-Remote UE 302 from its own perspective. This leads to the defining of second desired information for U2U relay discovery, for example, U2U interest, which represents that there exists a unilateral interest for the S-Remote UE 302 and T-Remote UE 306 to communicate.

Based on the above analysis, there can be two scenarios to be supported for relay discovery. In the first scenario, a remote UE has an interest to communicate with a peer UE, so receiving “U2U connectivity” information from a candidate U2U relay UE indicating its connectivity to a target remote UE is sufficient. In the second scenario, there exists a remote UE which is not aware of peer UE's interest. Thus, both “U2U connectivity” and “U2U interest” can be conveyed to this remote UE to trigger the follow-up action (e.g., relay selection).

The herein described embodiments relate to two different discovery schemes for a U2U relay discovery, a connectivity-based scheme and an interest-based scheme. Note that for each respective scheme, both the U2U connectivity and U2U interest information may be communicated in the discovery procedure. But the name of those schemes only suggests which information, “U2U connectivity” or “U2U interest,” plays the most primary role in the respective discovery procedures.

For the connectivity-based scheme, the relay UE is supposed to announce its “own” 1-hop connectivity, (e.g., the remote UE(s) it can reach). The approach is similar to a “route-update” messaging in routing protocols. This approach can further be extended to multi-hop cases by having the relay UE announcing information related to a number of hops used to reach the remote UE. “Multi-hop,” as used herein, refers to more than one hop. The remote UE can use the information from the relay UE to determine whether this relay is an appropriate candidate relay. An issue for this connectivity scheme can be how the relay UE comes up with the connectivity information, and how useful is the information. Also, the connectivity information may contain additional characteristics of the remote UE connectivity. For example, the PC5 link quality between remote UE and relay UE can be indicated, which can be based on the measurement of sidelink (SL) unicast measurement (e.g., sidelink-reference signal received power (SL-RSRP)) or an SL broadcast measurement (e.g., sidelink discovery-reference signal received power (SD-RSRP). Also, whether the PC5 link has already been established between remote UE and relay UE can also be indicated.

For an interest-based scheme, a relay UE can rebroadcast an “end-to-end” link interest (E2E link interest) received from a remote UE. Once a target remote UE (T-Remote UE) receives the “interest,” the T-Remote UE can determine whether to use this relay as a candidate relay for the “end-to-end” link. An issue for the interest-based scheme is that every relay is supposed to “rebroadcast,” which can create flooding issues and privacy issues related to the interests.

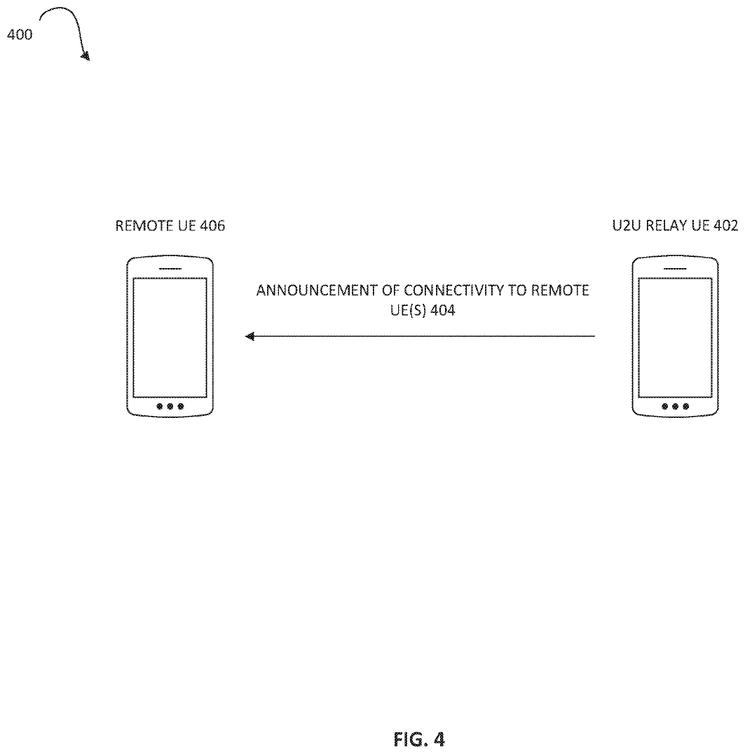

FIG. 4 is a signaling diagram 400 of a connectivity-based scheme for U2U relay discovery, according to one or more embodiments. For the connectivity-based scheme, a U2U relay UE can transmit an announcement 404 to a remote UE 406. The announcement can include an indication that the U2U relay UE 402 is connected to one or more other remote UEs. The announcement 404 can include connectivity information for the one or more other remote UEs. In some instances, the announcement 404 includes additional characteristics for connectivity, such as PC5 link quality or a ranking of each of the one or more other remote UEs. The announcement 404 can be broadcast to any UE within the vicinity of the U2U relay UE 402. Alternatively, the announcement 404 can be targeted to a particular remote UE 406.

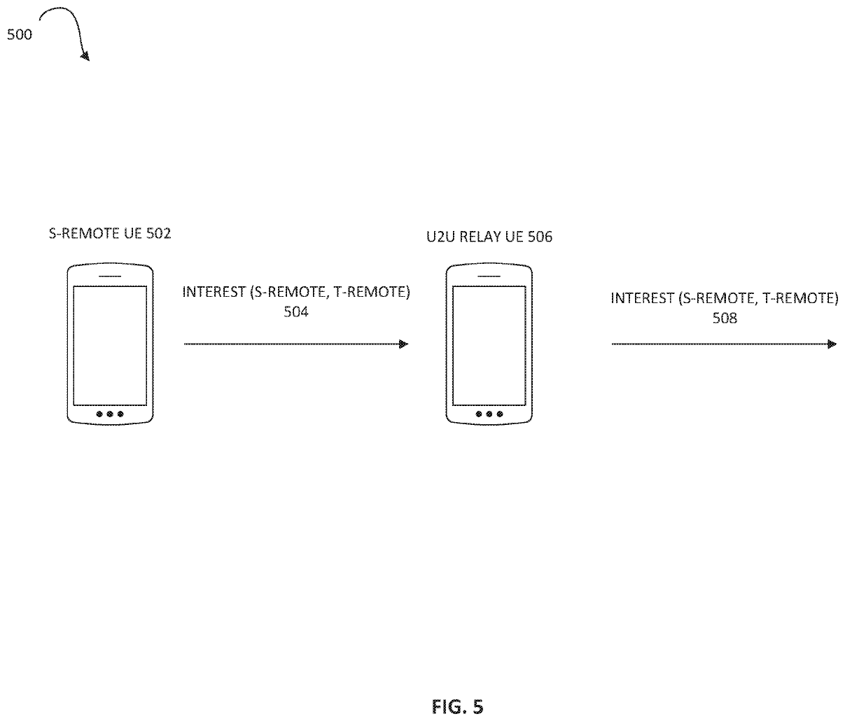

FIG. 5 is an illustration 500 of rebroadcasting for an interest-based scheme, according to one or more embodiments. An S-Remote UE 502 can transmit a first message 504 indicating an interest in connecting with another remote UE to the U2U relay UE 506. The U2U relay UE 506 can rebroadcast a second message 508 indicating an interest in connecting with another remote UE to one or more other remote UEs. In some instances, the U2U relay UE 506 may not further indicate in the second message 508 whether the S-Remote UE 502 is interested in one more hop when it is unable to determine whether it can reach a T-Remote UE in one hop. In other instances, the contents of the first message 504 is the same as the contents of the second message 508. In some embodiments, messages that include content related to connectivity also include content related to interest. In other embodiments, these messages that include content related to connectivity are separate from messages that include content related to interest. These messages can be designed based on connectivity content and interest content based on the procedures described in FIGS. 4 and 5.

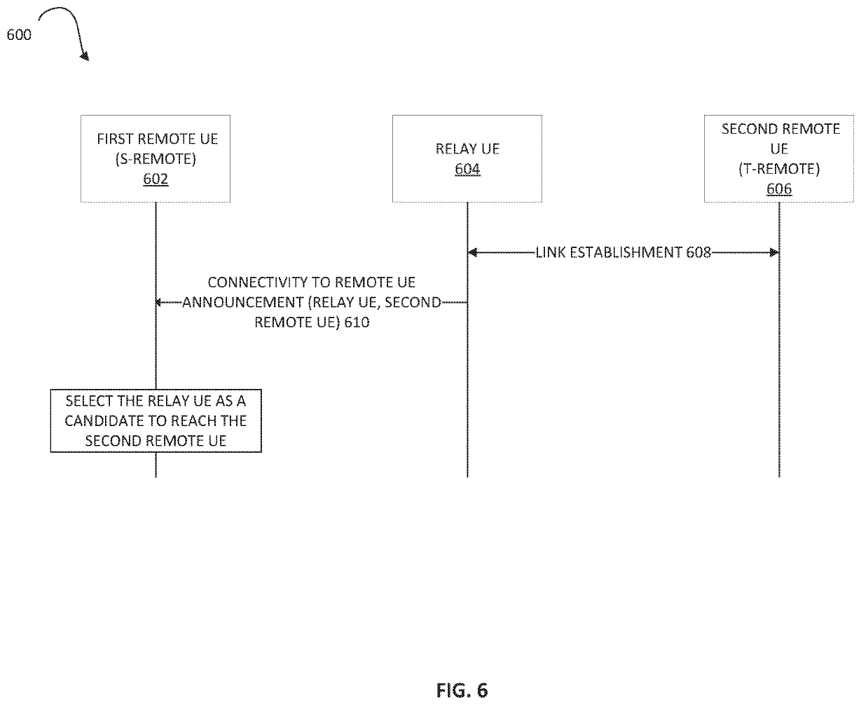

FIG. 6 is a signaling diagram 600 of a connectivity-based scheme for U2U relay discovery, according to one or more embodiments. As illustrated, a first remote UE 602, (e.g., an S-Remote UE), a relay UE 604 (e.g., U2U relay UE), and a second remote UE 606 (e.g., a T-Remote UE) can engage in a connectivity-based scheme. At 608, the relay UE 604 and the second remote UE 606 can establish a link. In this scheme, the relay UE 604 can collect information about connectivity to the second remote UE 606 based on information exchanged over the link. At 610, the relay UE 604 can transmit a discovery message that includes an announcement to the first remote UE 602. The announcement can include connectivity information for connecting with a T-Remote UE. The first remote UE 602 can select the relay UE 604 as a candidate to reach the second remote UE 606 based on the content of the discovery message received at step 610.

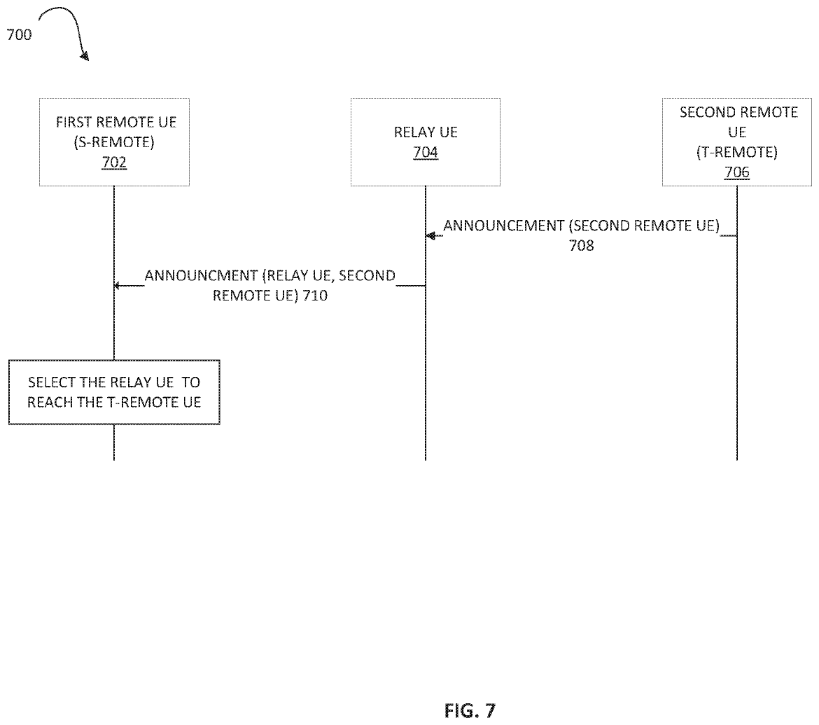

FIG. 7 is a signaling diagram 700 of a connectivity-based scheme for U2U relay discovery, according to one or more embodiments. As illustrated, a first remote UE 702, (e.g., an S-Remote UE), a relay UE 704 (e.g., U2U relay UE), and a second remote UE 706 (e.g., a T-Remote UE) can engage in a connectivity-based scheme. At 708, the second remote UE 706 can transmit a discovery message including an announcement message to the relay UE 704. The announcement message can be regarded as implicitly including connectivity information that any UEs in proximity receiving this announcement message are able to connect to a T-Remote UE. In this scheme, the relay UE 704 can collect information about the connectivity to the second remote UE 706 based on the content of the message. At 710, the relay UE 704 can transmit a message, including the announcement message to the first remote UE 702. The first remote UE 702 can select the relay UE 704 to reach the T-Remote UE 706 based on the content of the message received at step 710.

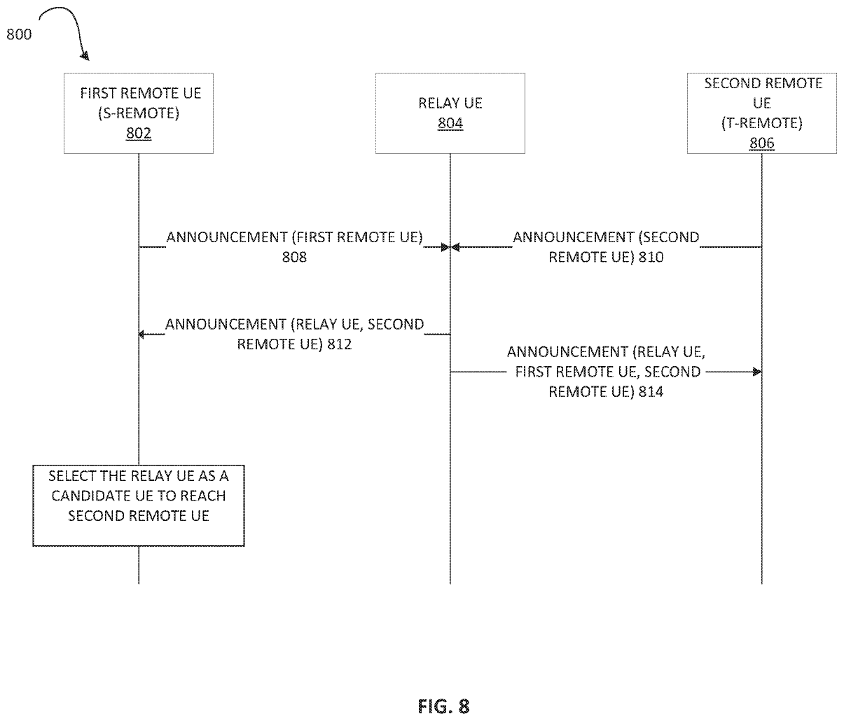

FIG. 8 is a signaling diagram 800 of a connectivity-based scheme for U2U relay discovery, according to one or more embodiments. As illustrated, a first remote UE 802, (e.g., an S-Remote UE), a relay UE 804 (e.g., U2U relay UE), and a second remote UE 806 (e.g., a T-Remote UE) can engage in a connectivity-based scheme. At 808, the first remote UE 802 can transmit a discovery message, including an announcement to the relay UE 804. The announcement can be regarded as implicitly including connectivity information for connecting with a S-Remote UE. It may also explicitly include any other 1-hop connectivity discovered by the S-Remote UE. At 810, the second remote UE 806 can also send a discovery message, including an announcement to the relay UE 804. The announcement can be regarded as implicitly including connectivity information for connecting to a T-Remote UE. It may also explicitly include any other 1-hop connectivity discovered by the T-Remote UE. Alternatively, this discovery message can also be combined with an interest-based scheme to include an indication to seek a relay to reach the second remote UE 806. In this scheme, the relay UE 804 can collect information about connectivity to the first remote UE 802 and the second remote UE 806 based on the contents of the messages. The relay UE 804 can further combine both announcements to generate a single announcement. At 812, the relay UE 804 can transmit the combined announcement to the first remote UE 802. At 814, the relay UE 804 can transmit the combined announcement to the second remote UE 806. At 516, the first remote UE 802 can select the relay to reach the second remote UE 806.

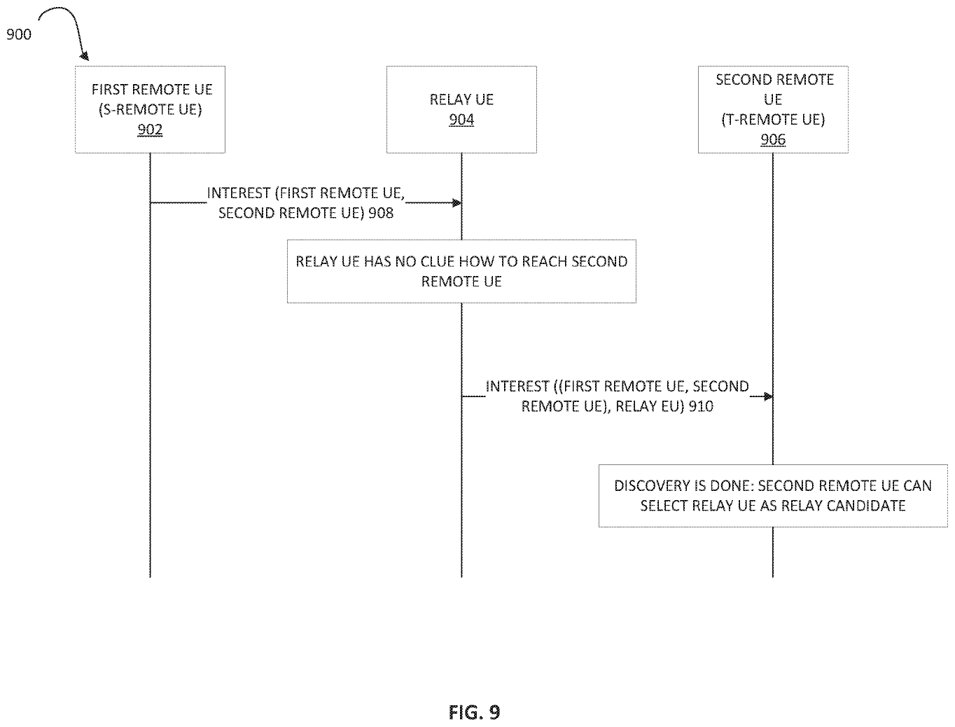

FIG. 9 is a signaling diagram 900 of an interest-based scheme for U2U relay discovery, according to one or more embodiments. As illustrated, a first remote UE 902, (e.g., an S-Remote UE), a relay UE 904, and a second remote UE 906 (e.g., a T-Remote UE) can engage in an interest-based scheme. At 908, the first remote UE 902 can broadcast a discovery message to the relay UE 904 that includes an indication of an end-to-end (E2E) interest, as compared to 1-hop connectivity information in connectivity-based schemes. In this instance, the relay UE 904 can have no information as to how to reach the second remote UE 906. At 910, the relay UE 904 can broadcast the first remote UE's discovery message and include its own relay information. If the second remote UE 906 is within the proximity of the relay UE 904, the second remote UE 906 can receive the message from the relay UE 904.

Here, upon receipt of the message, discovery is done, and the second remote UE 906 can select the relay UE 904 as a relay candidate to reach the first remote UE 902. Alternatively, the second remote UE 906 can also generate a U2U interest response message and send this message back to the relay UE 904. Then, the relay UE 904 can forward the U2U interest response message, together with its own relay UE information, to the first remote UE 902. In this case, the first remote UE can consider that the discovery is done from the first remote UE perspective, and the first remote UE 902 can select the relay UE 904 as a relay candidate UE to reach the second remote UE.

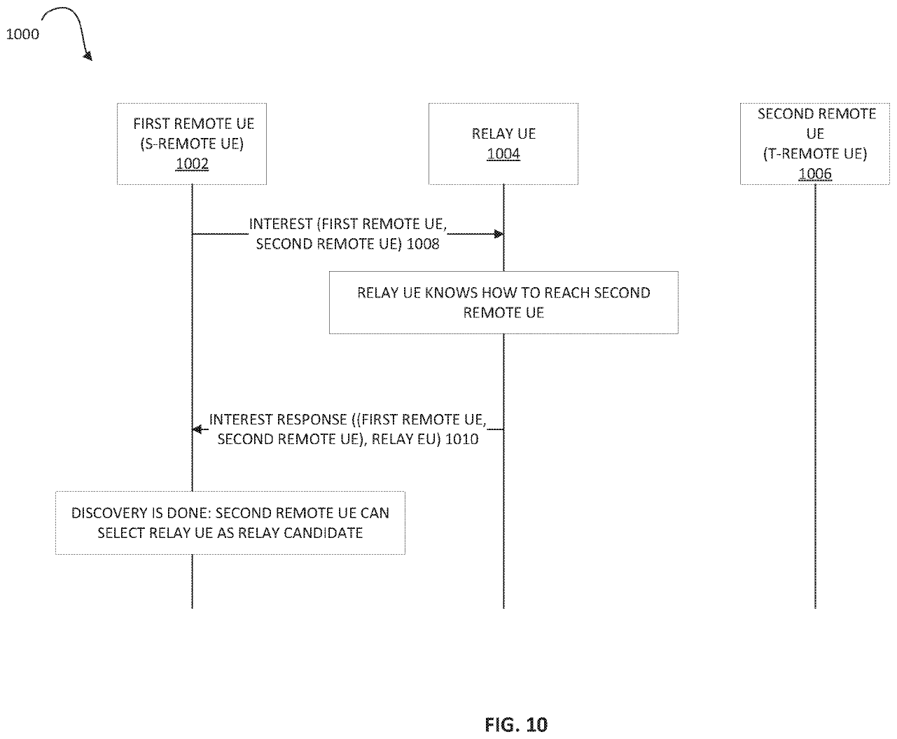

FIG. 10 is a signaling diagram 1000 of an interest-based scheme for U2U relay discovery, according to one or more embodiments. As illustrated, a first remote UE 1002, (e.g., an S-Remote UE), a relay UE 1004, and a second remote UE 1006 (e.g., a T-Remote UE) can engage in an interest-based scheme. At 1008, the first remote UE 1002 can broadcast a discovery message to the relay UE 1004 that includes an indication of an E2E interest. In this instance, the relay UE 1004 can have information that it can use to reach the second remote UE 1006. At 1010, the relay UE 1004 can transmit a response message to the first remote UE 1002 to acknowledge its ability to meet the E2E interest of the first remote UE 1002, and i nclude relay information. Here, upon receipt of the message from the relay UE 1004, discovery is done, and the first remote UE 1002 can select the relay UE 1004 as a relay candidate to reach the second remote UE 1006.

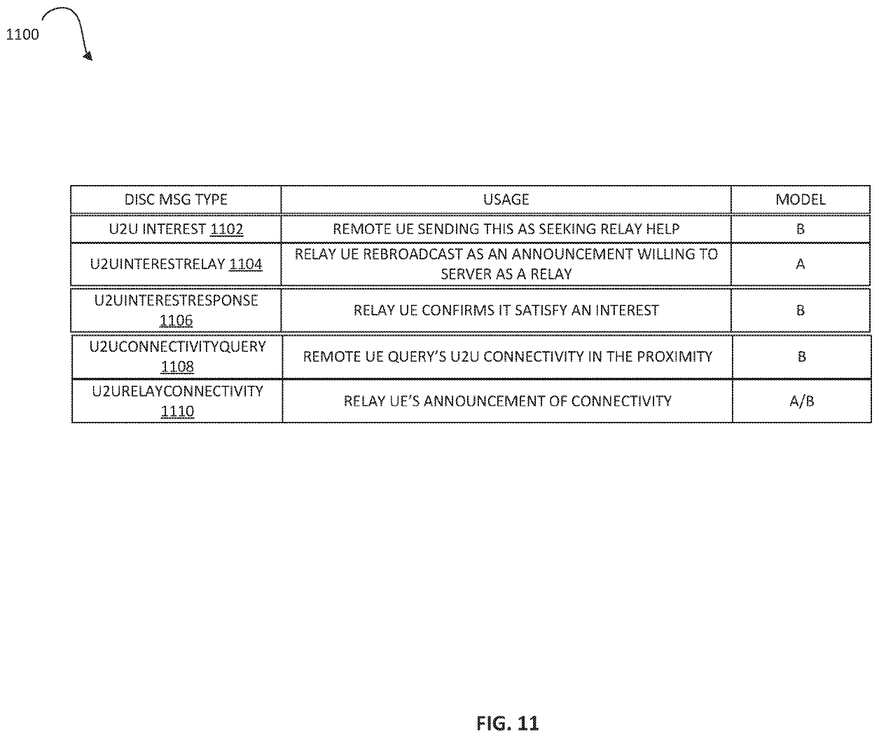

FIG. 11 is an illustration of a table 1100 of discovery message types, according to one or more embodiments. The message types add to the discovery message types as defined in 3GPP TS 24.554. For U2U connectivity-based schemes, the discovery message types include a relay UE connectivity announcement message and a relay UE connectivity response message. The message types also include a remote UE query message and a remote UE announcement message. For U2U interest-based schemes, the discovery message types include a relay UE interest rebroadcasting message, a relay UE interest response message, and a remote UE interest message.

The table 1100 includes a U2U interest message 1102, for sending a remote UE sending request for relay help. The table 1100 includes a U2Uinterestrelay message 1104, for a relay UE rebroadcasting an announcement of a willingness to serve as a relay UE. The table includes a U2Uinterest response message 1106, for a relay UE confirming that it can satisfy an interest. The table 1100 a U2Uconnectivityquery message 1108, for a remote UE's query as to connectivity within its proximity. The table includes a U2Urelayconnectivity message 1110, a relay UE's announcement of connectivity. The messages are described further with respect to FIGS. 9-12. It should be appreciated that the content of one or more of these messages can be combined into a single message. For example, in some instances a UE can be transmitting to more than one other UE and the UE can combine more than one message into a single message, where respective portions of the message are to be received by different UEs.

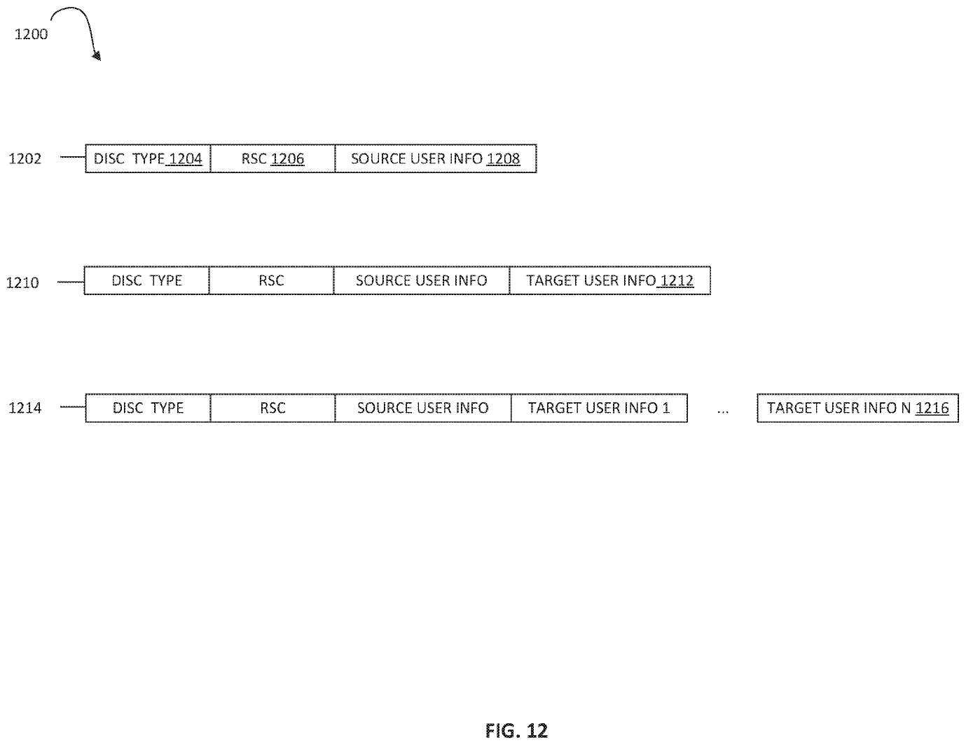

FIG. 12 is an illustration 1200 of remote UE discovery messages, according to one or more embodiments. As described with respect to FIG. 11, two remote UE message design choice options are defined: a U2Uconnectivityquery message 1108 and a U2U interest message 1102. For a first option 1202, the U2Uconnectivityquery message can include a discovery message type 1204, which can be indicated by the PC5 discovery message type, (which can also be used to differentiate direct discovery, U2N discovery, and U2U relay discovery, relay service code) 1206, and source user information 1208 (e.g., source remote UE information).

For a second option 1210, a U2Uinterest message can include a discovery message type, an RSC, source user information, and target user information 1212. For this message, the relay UE can use different discovery messages for each different target UE that the relay UE tries to reach. For the first option and the second option, both messages can be the same discovery message type, with the difference being whether the message includes a “target.” In other words, the second option can be a targeted message.

A third option 1214 can include an optimized discovery message for advanced designs and can include multiple <S-Remote UE, T-Remote UE> from the same remote UE into one discovery message. The third option can include a message with a discovery type, an RSC, source user information, and multiple target source information instances 1216. In other words, the third option can include multiple target UEs. In another embodiment, the third option can include multiple source UEs information and multiple target UEs information. Each of the source UEs can be associated with a respective target UE, such as a message from a source UE can be intended for a respective target UE.

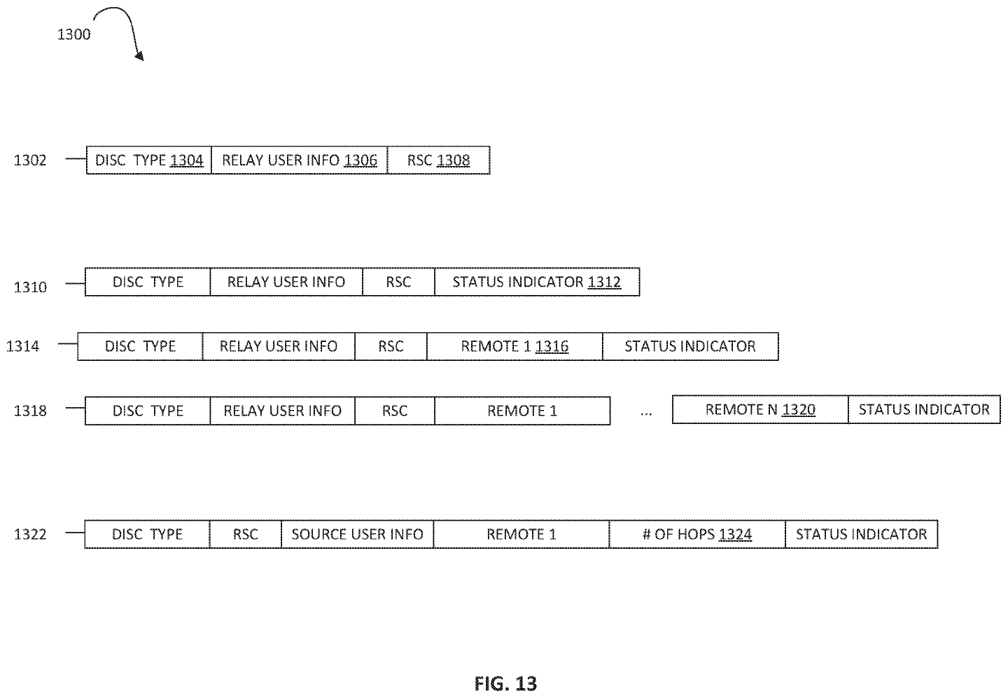

FIG. 13 is an illustration 1300 of U2URelayconnectivity messages for layer 2 (L2) U2U relay discovery, according to one or more embodiments. After a U2U relay UE processes a remote UE model B discovery message for a U2U relay, the U2U relay UE can build a one-to-one relationship between a remote UE L2 identifier (ID) and a corresponding RSC. This entry can also contain the remote UE's interest (e.g., a list of target user information). A U2U relay message can announce, an ability to serve as a U2U relay, at least for a particular RSC; the U2U relay UE's connectivity to reach remote UEs.

A first option 1302 for a U2URelayconnectivity message can include a discovery type 1304, relay user information 1306 (e.g., relay UE information), and an RSC 1308. A second option 1310 for a U2URelayconnectivity message can include a discovery message type, relay user information, an RSC, and a status indicator 1312. A third option 1314 for a U2URelayconnectivity message can include a discovery message type, relay user information, remote 1 1316 (e.g., a first remote UE information), and a status indicator. For different relay service (e.g., represented by different RSC (relay service code). A relay UE can use different discovery message. Similarly, for each different target UE that the relay UE can reach, the relay UE can also put the target UE information in a different U2URelayconnectivity message. A fourth option 1318 for a U2URelayconnectivity message can include a discovery message type, a relay user information, an RSC, multiple remote instances 1320 (e.g., multiple remote UE information instances), and a status indicator. A fifth option 1322 can be an extension that accounts for multiple hop connectivity. The fifth option 1322 for a U2URelayconnectivity message can include a discovery message type, a relay user information, an RSC, source user information, remote instance, a number of hops 1324, and a status indicator.

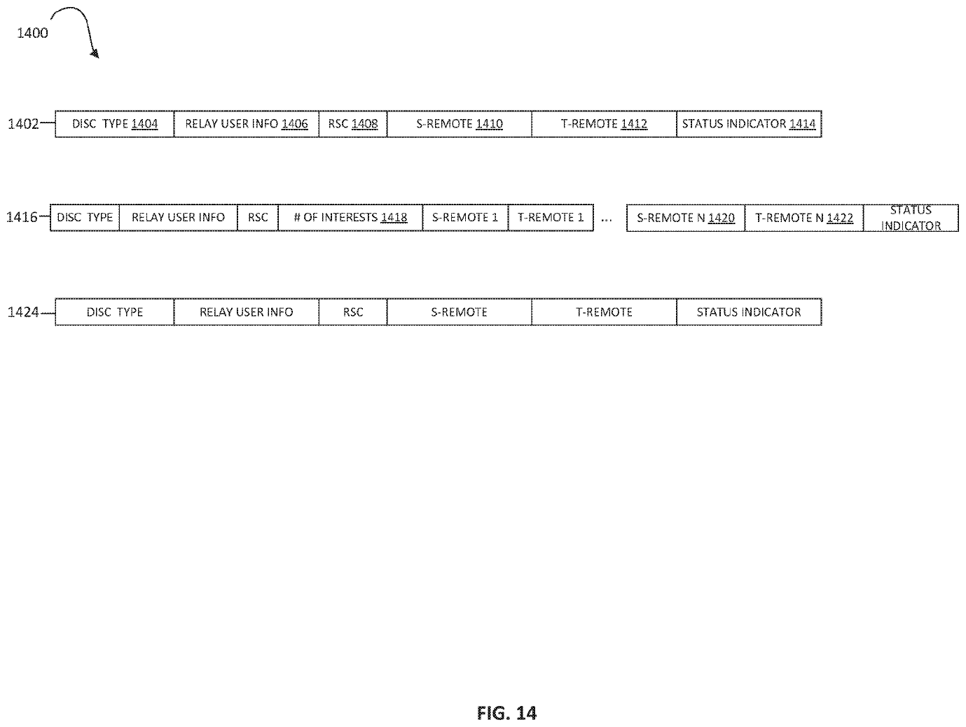

FIG. 14 is an illustration 1400 of U2Uinterestrelay messages and U2Uinterestresponse messages for L2 U2U relay discovery, according to one or more embodiments. A U2U relay discovery message can rebroadcast the interests received from a nearby remote UE. The relay discovery message can indicate the UE's willingness to serve as a relay for E2E link interest of <S-Remote UE, T-Remote UE>, but further indicate that at this time, the relay UE is not sure it can reach the T-Remote UE yet. A first option 1402 for a U2Uinterestrelay message can include a discovery message type 1404, a relay user info 1406, an RSC 1408, an S-Remote 1410 (e.g., S-Remote UE information), a T-Remote 1412 (e.g., a T-Remote UE information), and a status indicator 1414. The PC5 discovery message type 1104 can indicate that this is a relay rebroadcast of the E2E interests. This does not mean that the relay is able to reach the target remote UE. To reduce the number of messages, multiple interests can be combined into one message. Therefore, a second option 1416 for a U2Uinterestrelay message can include a discovery message type, a relay user info, an RSC, a number of interests 1418, multiple S-Remote instances 1420, multiple T-Remote instances 1422, and a status indicator.

A U2Uinterestrelay message 1424 can include a discovery message type, a relay user info, an RSC, an S-Remote, a T-Remote, and a status indicator. The PC5 discovery type can indicate that this is a conformation/response to the remote UE (e.g., an S-Remote UE) that the relay UE is able to reach the target remote UE (e.g., a T-Remote UE).

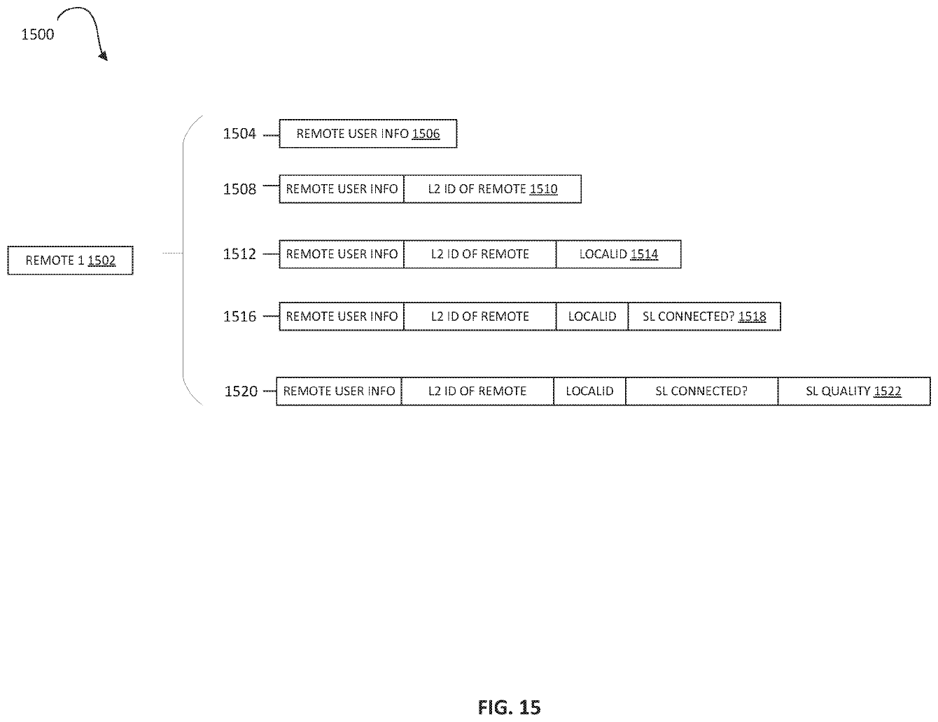

FIG. 15 is an illustration 1500 of remote UE representations for L2 U2U relay discovery, according to one or more embodiments. A variety of information can be used in a U2U relay UE's relay discovery message to help describe the remote UE information 1506. A first option 1504 of a remote UE representation can include remote user information 1506. A second option 1508 of a remote UE representation can include remote user information and an L2 ID of the remote UE 1510. A third option 1512 of a remote UE representation can include remote user information, L2 ID of the remote UE, and a local identifier 1514, wherein the local identifier 1514 can be assigned to the remote UE (e.g., by a relay UE). The local identifier 1514 is included, if the relay UE already has a link to the T-remote UE. In some instances, the relay UE may have a respective link with multiple remote UEs. In these instances, the relay UE can use the local identifier to distinguish the T-Remote UE from other remote UEs of the multiple remote UEs. A fourth option 1516 of a remote UE representation can include remote user information, L2 ID of the remote UE, and a local identifier, and an indication of whether a sidelink (SL) relay is connected 1518. A fifth option 1520 of a remote UE representation can include remote user information, L2 ID of the remote UE, and a local identifier, and an indication of whether a sidelink (SL) relay is connected, and an indication of the quality of the SL relay 1522 (e.g., a PC5 link quality, such as SL-received signal reference power (SL-RSRP). In some other embodiments, one or more of the above-described information elements can be omitted or rearranged in a different order.

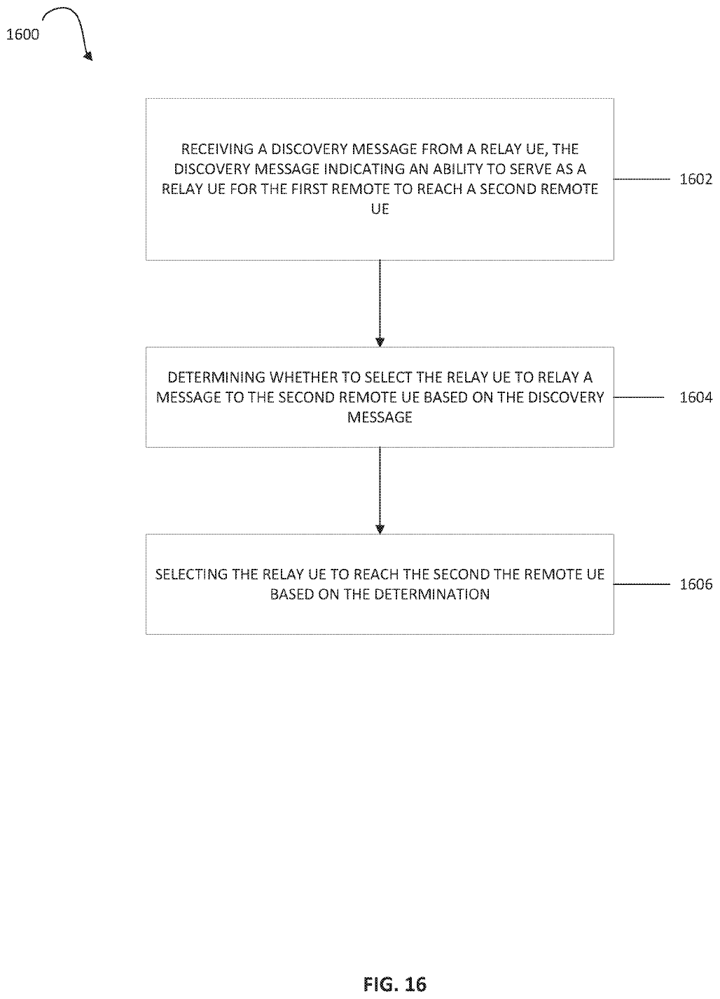

FIG. 16 is a process flow 1600 for selecting a relay, according to one or more embodiments. At 1602, the method can include a first remote user equipment (UE), receiving a discovery message from a relay UE. The first remote UE can be an S-Remote UE that is searching for a connection to a T-Remote UE. The discovery message can include an announcement indicating an ability to serve as the relay UE for the first remote UE to reach a second remote UE. The relay UE may or may not be in connection with a T-Remote UE that can connect the S-Remote UE. In some instances, the discovery message can be transmitted based on connectivity information received from the second remote UE by the relay UE. The connectivity information can be received based on a link between the relay UE and the second remote UE, the connectivity information can be received based on an announcement by the second remote UE, or connectivity information can be received based on other appropriate information received from the second remote UE via the relay UE.

At 1604, the method can include the first remote UE determining whether to select the relay UE to relay a message to the second remote UE based on the discovery message. The decision can be based on various factors, for example, a number of hops, an identity of the T-Remote UE, or other appropriate factors.

At 1606, the method can include the first remote UE selecting the relay UE to reach the second remote UE based on the determination. The first remote message can then relay messages to and from the second remote UE.

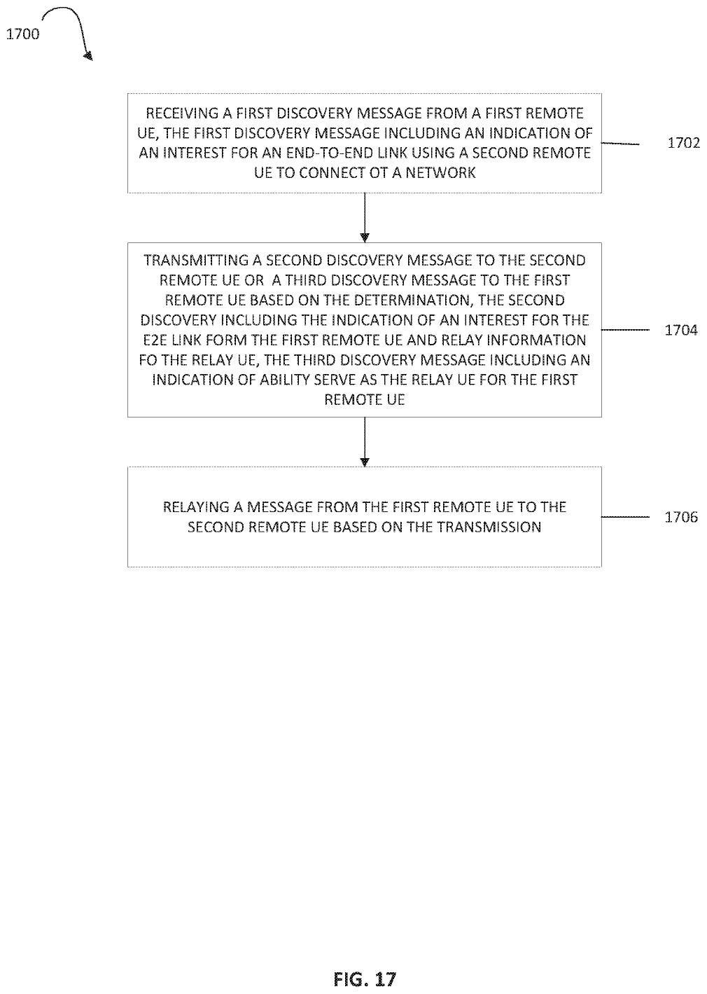

FIG. 17 is a process flow 1700 for selecting a relay, according to one or more embodiments. At 1702, the method can include a relay UE receiving a first discovery message from a first remote UE. The first remote UE can be a S-Remote UE. The first discovery message can include an indication of an interest for an end-to-end (E2E) link with a second remote UE. The second remote UE can be a T-Remote UE.

At 1704, the method can include the relay UE transmitting a second discovery message to the second remote UE or a third discovery message to the first remote UE based on the determination. If the relay UE does include information to connect to the second remote UE, the relay UE can transmit the second discovery message. The second discovery message including the indication of the interest for the E2E link from the first remote UE and relay information of the relay UE. If the relay UE does include information to connect to the second remote UE, the relay UE can transmit the third discovery message, which includes an indication of an ability to serve as the relay UE for the first remote UE.

At 1706, the method can include the relay UE relaying a message from the first remote UE to the second remote UE based on the transmission.

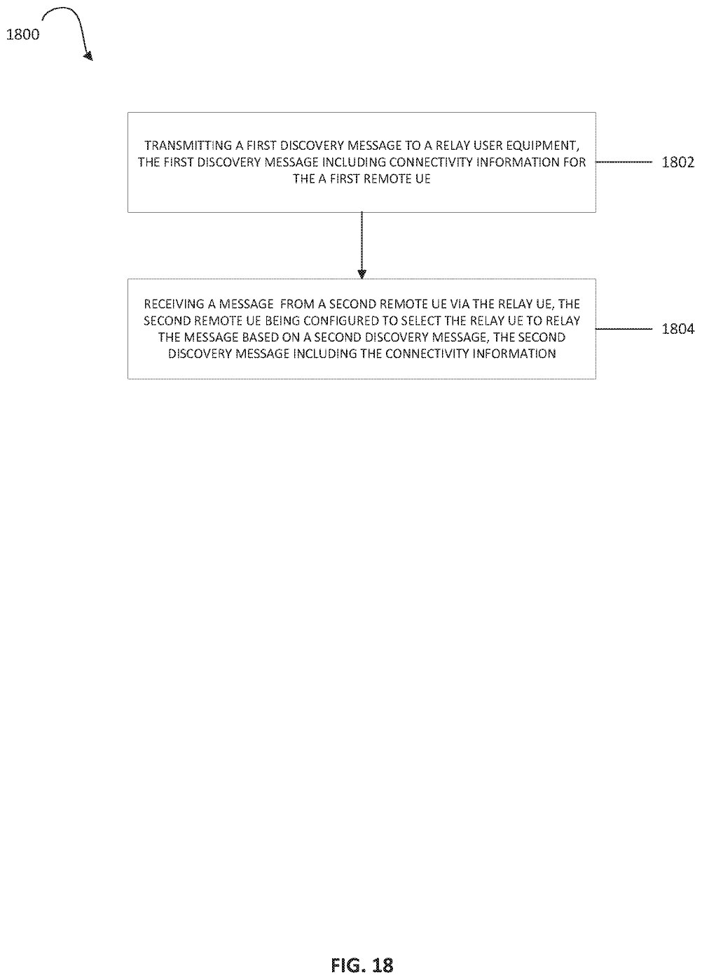

FIG. 18 is a process flow 1800 for selecting a relay, according to one or more embodiments. At 1802, the method can include a first remote UE transmitting a first discovery message to a relay UE. The first remote UE can be a T-Remote UE. The first discovery message can include connectivity information for the first remote UE.

At 1804, the method can include the first remote UE receiving a message from a second remote UE via the relay UE. The second remote UE being configured to select the relay UE to relay the message based on a second discovery message. The second discovery message can include the connectivity information.

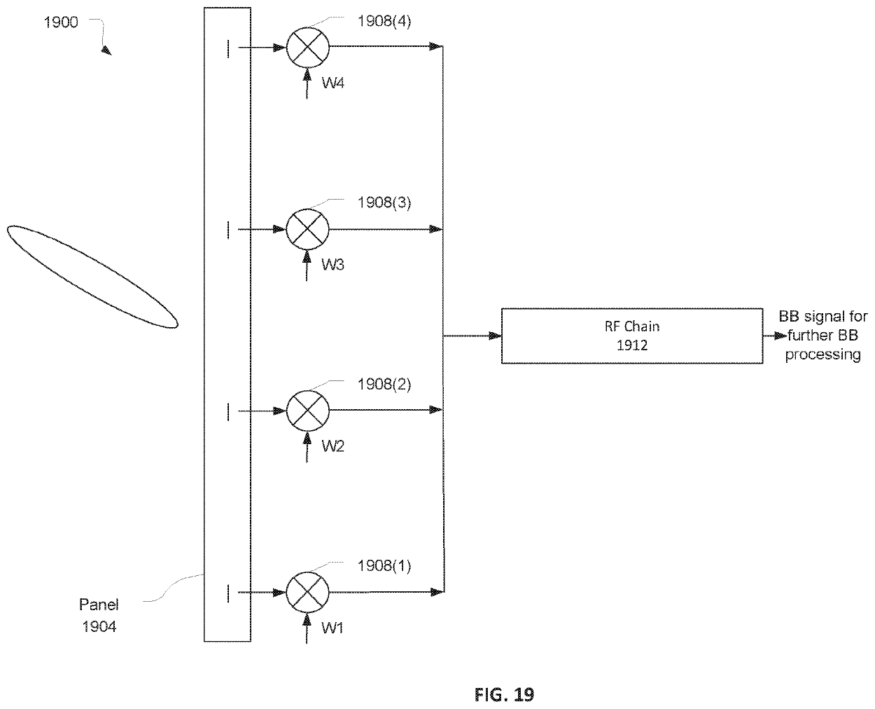

FIG. 19 illustrates receive components 1900 of a UE, according to one or more embodiments. The receive components 1900 may include an antenna panel 1904 that includes a number of antenna elements. The panel 1904 is shown with four antenna elements, but other embodiments may include other numbers.

The antenna panel 1904 may be coupled to analog beamforming (BF) components that include a number of phase shifters 1908(1)-1908(4). The phase shifters 1908(1)-1908(4) may be coupled with a radio-frequency (RF) chain 1912. The RF chain 1912 may amplify a received analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1908(1)-1908(4) to provide a receive beam at the antenna panel 1904. These BF weights may be determined based on the channel-based beamforming.

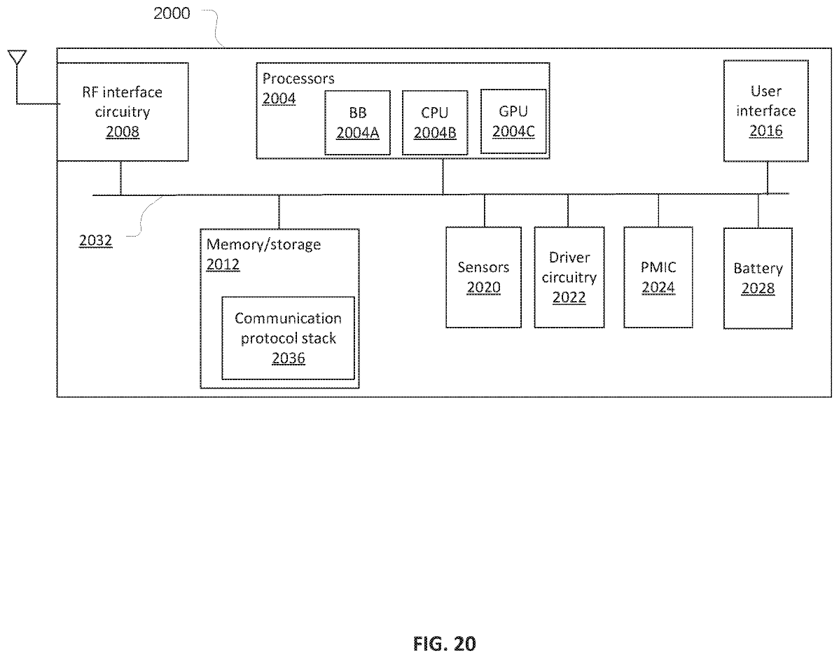

FIG. 20 illustrates a UE 2000, according to one or more embodiments. The UE 2000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 2000 may include processors 2004, RF interface circuitry 2008, memory/storage 2012, user interface 2016, sensors 2020, driver circuitry 2022, power management integrated circuit (PMIC) 2024, and battery 2028. The components of the UE 2000 may be implemented as integrated circuits (ICs), portions thereof, discrete electronic devices, or other modules, logic, hardware, software, firmware, or a combination thereof. The block diagram of FIG. 20 is intended to show a high-level view of some of the components of the UE 2000. However, some of the components shown may be omitted, additional components may be present, and different arrangements of the components shown may occur in other implementations.

The components of the UE 2000 may be coupled with various other components over one or more interconnects 2032, which may represent any type of interface, input/output, bus (local, system, or expansion), transmission line, trace, optical connection, etc. that allows various circuit components (on common or different chips or chipsets) to interact with one another.

The processors 2004 may include processor circuitry such as, for example, baseband processor circuitry (BB) 2004A, central processor unit circuitry (CPU) 2004B, and graphics processor unit circuitry (GPU) 2004C. The processors 2004 may include any type of circuitry or processor circuitry that executes or otherwise operates computer-executable instructions, such as program code, software modules, or functional processes from memory/storage 2012 to cause the UE 2000 to perform operations as described herein.

In some embodiments, the baseband processor circuitry 2004A may access a communication protocol stack 2036 in the memory/storage 2012 to communicate over a 3GPP compatible network. In general, the baseband processor circuitry 2004A may access the communication protocol stack to: perform user plane functions at a PHY layer, MAC layer, RLC layer, PDCP layer, SDAP layer, and PDU layer, and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 2008.

The baseband processor circuitry 2004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 2004A may also access group information 2024 from memory/storage 2012 to determine search space groups in which a number of repetitions of a PDCCH may be transmitted.

The memory/storage 2012 may include any type of volatile or non-volatile memory that may be distributed throughout the UE 2000. In some embodiments, some of the memory/storage 2012 may be located on the processors 2004 themselves (for example, L1 and L2 cache), while other memory/storage 2012 is external to the processors 2004 but accessible thereto via a memory interface. The memory/storage 2012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2008 may include transceiver circuitry and a radio frequency front module (RFEM) that allows the UE 2000 to communicate with other devices over a radio access network. The RF interface circuitry 2008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 2024 and proceed to filter and amplify (with a low-noise amplifier) the signal. The signal may be provided to a receiver of the transceiver that down-converts the RF signal into a baseband signal that is provided to the baseband processor of the processors 2004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 2024.

In various embodiments, the RF interface circuitry 2008 may be configured to transmit/receive signals in a manner compatible with NR access technologies.

The antenna 2024 may include a number of antenna elements that each convert electrical signals into radio waves to travel through the air and to convert received radio waves into electrical signals. The antenna elements may be arranged into one or more antenna panels. The antenna 2024 may have antenna panels that are omnidirectional, directional, or a combination thereof to enable beamforming and multiple input, multiple output communications. The antenna 2024 may include microstrip antennas, printed antennas fabricated on the surface of one or more printed circuit boards, patch antennas, phased array antennas, etc. The antenna 2024 may have one or more panels designed for specific frequency bands including bands in FR1 or FR2.

The user interface circuitry 2016 includes various input/output (I/O) devices designed to enable user interaction with the UE 2000. The user interface 2016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 2000.

The sensors 2020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2022 may include software and hardware elements that operate to control particular devices that are embedded in the UE 2000, attached to the UE 2000, or otherwise communicatively coupled with the UE 2000. The driver circuitry 2022 may include individual drivers allowing other components to interact with or control various input/output (I/O) devices that may be present within, or connected to, the UE 2000. For example, driver circuitry 2022 may include a display driver to control and allow access to a display device, a touchscreen driver to control and allow access to a touchscreen interface, sensor drivers to obtain sensor readings of sensor circuitry 2020 and control and allow access to sensor circuitry 2020, drivers to obtain actuator positions of electro-mechanic components or control and allow access to the electro-mechanic components, a camera driver to control and allow access to an embedded image capture device, audio drivers to control and allow access to one or more audio devices.

The PMIC 2024 may manage power provided to various components of the UE 2000. In particular, with respect to the processors 2004, the PMIC 2024 may control power-source selection, voltage scaling, battery charging, or DC-to-DC conversion.

In some embodiments, the PMIC 2024 may control, or otherwise be part of, various power saving mechanisms of the UE 2000. For example, if the platform UE is in an RRC Connected state, where it is still connected to the RAN node as it expects to receive traffic shortly, then it may enter a state known as Discontinuous Reception Mode (DRX) after a period of inactivity. During this state, the UE 2000 may power down for brief intervals of time and thus save power. If there is no data traffic activity for an extended period of time, then the UE 2000 may transition off to an RRC_Idle state, where it disconnects from the network and does not perform operations such as channel quality feedback, handover, etc.

The UE 2000 goes into a very low power state, and it performs paging where again it periodically wakes up to listen to the network and then powers down again. The UE 2000 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2028 may power the UE 2000, although in some examples the UE 2000 may be mounted deployed in a fixed location and may have a power supply coupled to an electrical grid. The battery 2028 may be a lithium ion battery, a metal-air battery, such as a zinc-air battery, an aluminum-air battery, a lithium-air battery, and the like. In some implementations, such as in vehicle-based applications, the battery 2028 may be a typical lead-acid automotive battery.

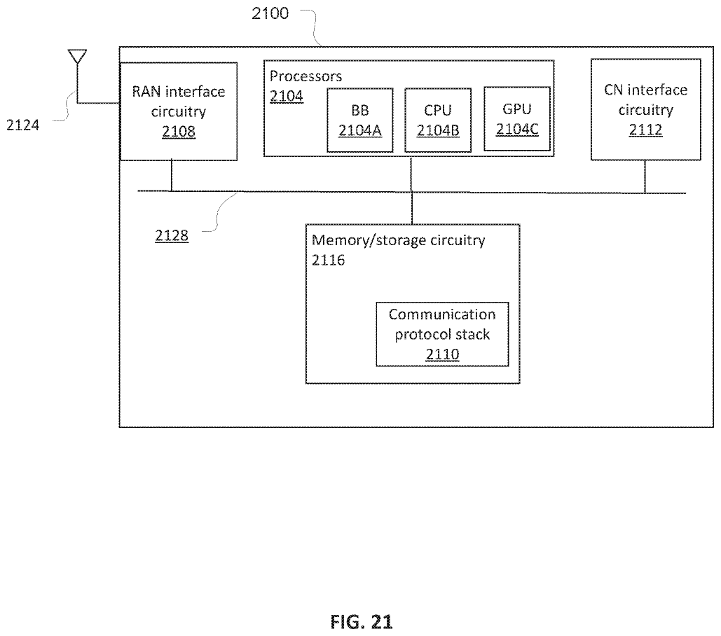

FIG. 21 illustrates a gNB 2100, according to one or more embodiments. The gNB 2100 may include processors 2104, RF interface circuitry 2108, core network (CN) interface circuitry 2112, and memory/storage circuitry 2116.

The components of the gNB 2100 may be coupled with various other components over one or more interconnects 2128.

The processors 2104, RF interface circuitry 2108, memory/storage circuitry 2116 (including communication protocol stack 2110), antenna 2124, and interconnects 2128 may be similar to like-named elements shown and described with respect to FIG. 19.

The CN interface circuitry 2112 may provide connectivity to a core network, for example, a 5th Generation Core network (5GC) using a 5GC-compatible network interface protocol such as carrier Ethernet protocols, or some other suitable protocol. Network connectivity may be provided to/from the gNB 2100 via a fiber optic or wireless backhaul. The CN interface circuitry 2112 may include one or more dedicated processors or FPGAs to communicate using one or more of the aforementioned protocols. In some implementations, the CN interface circuitry 2112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided

Example 1 includes a method, comprising a first remote user equipment (UE)receiving a discovery message from a relay UE, the discovery message indicating an ability to serve as the relay UE for the first remote UE to reach a second remote UE. The first remote UE determining to select the relay UE to relay a message to the second remote UE based on the discovery message. The first remote UE selecting the relay UE to reach the second remote UE based on the determination.

Example 2 includes the method of example 1, the discovery message is transmitted as the relay UE determines connectivity to the second remote UE, wherein the determination of connectivity is based on information received from the second remote UE.

Example 3 includes the method of example 1 or 2, wherein the connectivity to the second remote UE is determined based on the relay UE having established a link with the second remote UE.

Example 4 includes the method of any of examples 1-3, wherein the discovery message is a first discovery message, wherein the first discovery message received by the first remote UE is based on the relay UE receiving a second discovery message from the second remote UE, wherein the second discovery message includes the connectivity information for the second remote UE, and wherein the relay UE is configured to include the connectivity information in the first message transmitted to the first remote UE

Example 5 includes the method of any of examples 1-4, wherein the discovery message is a first discovery message, and wherein the method further comprises: transmitting a second discovery message to the relay UE, wherein the second discovery message includes an indication for seeking a relay to the second remote UE; receiving the first discovery message from the relay UE in response to the second discovery message, wherein the first discovery message is a combination of the second discovery message and a third discovery message from the second remote UE, wherein the third discovery message is from the second remote UE and includes the connectivity information.

Example 6 includes the method of any of examples 1-5, wherein the second discovery message further includes a discovery type, a relay service code (RSC), and first remote UE information.

Example 7 includes the method of any of examples 1-6, wherein the discovery message includes a discovery type, the indication of the ability to serve as a user equipment-to-user equipment (U2U) relay UE based on a relay service code, and the RSC.

Example 8 includes the method of any of examples 1-7, wherein the discovery message further includes second remote UE information, a status indicator, or a number of hops to reach the second remote UE.

Example 9 includes a system comprising means to perform one or more elements of a method described in or related to examples 1-8.

Example 10 includes a computer-readable medium having stored thereon a sequence of instructions which, when executed, causes a processor to perform operations including a method described in or related to examples 1-8.

Example 11 includes a relay UE, comprising one or more processors; a communication interface; radio frequency (RF) interface circuitry; and a computer-readable medium including instructions that, when executed by the one or more processors, cause the relay UE to: receive a first discovery message from a first emote UE, the first discovery message including an indication of an interest for an end-to-end (E2E) link with a second remote UE; and transmit a second discovery message to the second remote UE or a third discovery message to the first remote UE based on the determination, the second discovery message to include the indication of the interest for the E2E link from the first remote UE and relay information of the relay UE, the third discovery message to include an indication of an ability to serve as the UE-to UE relay UE for the first remote UE to reach the second remote UE.

Example 12 includes the relay UE of example 11, wherein the third discovery message to the first remote UE is transmitted based on the relay UE determining that the relay UE is capable of communicating with the second remote UE over an interface.

Example 13 includes the relay UE of example 11 or 12, wherein the second remote UE is configured to determine whether to use the relay UE is relay the message based on the second discovery message.

Example 14 includes the relay UE of any of examples 11-13, wherein the relay UE includes information to reach the second remote UE, and wherein the relay UE transmits the third discovery message to the first remote UE, and wherein first remote UE is configured to determine whether to use the relay UE is relay the messages based on the third message.

Example 15 includes the relay UE of any of examples 11-14, wherein the first discovery message includes a discovery message type, a relay service code (RSC), first remote UE information, or second remote UE information.

Example 16 includes the relay UE of any of example 15, wherein the first discovery message further includes the second remote UE information and a third remote UE information.

Example 17 includes the relay UE of any of examples 11-16, wherein the second discovery message includes a discovery message type, relay UE information, or a relay service code.

Example 18 includes the relay UE of example 17, wherein the second discovery message further includes second remote UE information, and second remote UE information including a layer 2 identifier (L2 ID).

Example 19 includes the relay UE of any of examples 11-18, wherein the second discovery message further includes a local identifier for the second remote UE based on the relay UE having a link with the second remote UE, and wherein the relay UE intends to use the local identifier to distinguish a third remote UE that is linked the relay UE.

Example 20 includes the relay UE of any of examples 11-19, wherein the second discovery message further includes a PC5 link quality based on the relay UE and the second remote UE being sidelink (SL) connected.

Example 21 includes a system comprising means to perform one or more elements of a method described in or related to examples 11-20.

Example 22 includes a computer-readable medium having stored thereon a sequence of instructions which, when executed, causes a processor to perform operations including a method described in or related to examples 11-20.

Example 23 includes one or more computer-readable media including stored thereon instructions that, when executed by one or more processors, cause a user equipment (UE) to: transmit a first discovery message to a relay user equipment (UE), the first discovery message including connectivity information for a first remote UE; and receive a message from a second remote UE via the relay UE, the second remote UE being configured to select the relay UE to relay the message based on a second discovery message, the second discovery message including the connectivity information.

Example 24 includes the one or more computer-readable media of example 23, wherein instructions that, when executed by a processor, further causes the processor to perform operations comprising receiving a second discovery message from the relay UE, the second discovery message including the connectivity information for the first remote UE and connectivity information for the second remote UE.

Example 25 includes a computer-readable medium having stored thereon a sequence of instructions which, when executed, causes a processor to perform operations including a method described in or related to examples 23 and 24.

Example 26 includes a system comprising means to perform one or more elements of a method described in or related to examples 23 and 24.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method comprising:
receiving a message comprising first connectivity information from a first remote user equipment (UE); and
generating, for transmission to the first remote UE, a first discovery message based on receiving the message, the first discovery message indicating an ability for providing an end-to-end (E2E) link with a second remote UE; and
generating, for transmission to the second remote UE, a second discovery message based on receiving the message, the second discovery message indicating an ability to provide the E2E link.

22. The method of claim 21, further comprising:
determining connectivity with the first remote UE based on the message from the first remote UE.

23. The method of claim 22, wherein the connectivity to the first remote UE is determined based on having established a link with the first remote UE.

24. The method of claim 21, wherein the message is a first message, and the method further comprising:
receiving a second message comprising second connectivity information from the second remote UE, wherein the first message comprises connectivity information with the second remote UE, and wherein the second message comprises connectivity information for connecting with the first remote UE.

25. The method of claim 21, wherein the message is a first message, and the method further comprising:
receiving a second message from the first remote UE indicating seeking an E2E link with the second remote UE.

26. The method of claim 21, wherein the first discovery message indicates a link quality for a link with the second remote UE.

27. The method of claim 21, wherein the message is a first message, and the method further comprising:
receiving a second message comprising second connectivity information from the second remote UE; and
combining the first message and the second message, wherein the first discovery message and the second discovery message each comprise the combination of the first message and the second message.

28. The method of claim 21, wherein the first discovery message comprises:
a discovery message type and a relay service code (RSC).

29. The method of claim 21, wherein the first discovery message further comprises:
a status indicator.

30. A device comprising:
processor circuitry to:
receive, from a first remote user equipment (UE), a message comprising an indication that the first remote UE seeks an end-to-end (E2E) link with a second remote UE;
generate, for transmission to the second remote UE, a first discovery message that includes: the indication that the first remote UE seeks an end-to-end (E2E) link with a second remote UE; and connectivity information for the first remote UE; and
interface circuitry coupled with the processor circuitry to enable communication.

31. The device of claim 30, wherein the first discovery message further includes a discovery message type, a status indicator, and a relay service code (RSC).

32. The device of claim 30, wherein the first discovery message includes a discovery message type, device relay information, and an RSC.

33. The device of claim 30, wherein the second remote UE is configured to determine whether to use the device as a relay device based on the first discovery message.

34. The device of claim 30, wherein the device has not stored information or reaching the second remote UE prior to transmitting the first discovery message.

35. The device of claim 30, wherein the device has stored information to reach the second remote UE, and wherein the device transmit the first discovery message based on the stored information for reaching the second remote UE.

36. The device of claim 30, wherein the first discovery message further includes a local identifier for the second remote UE based on the device having a link with the second remote UE, and wherein the device is configured to use the local identifier to distinguish the second remote UE from a third remote UE that is linked the device.

37. The device of claim 30, wherein the first discovery message further includes a PC5 link quality based on the device and the second remote UE being sidelink (SL) connected.

38. The device of claim 30, wherein the first discovery message further comprises a layer 2 identifier (L2 ID) associated with the second remote UE.

39. One or more non-transitory, computer-readable media including stored thereon instructions that, when executed, cause a device to:
generate, for transmission to a relay user equipment (UE), a first message that includes first connectivity information for a first remote UE; and
receive a second message from the relay UE, the second message including second connectivity information for a second remote UE.

40. The one or more non-transitory, computer-readable media of claim 39, wherein the second message further comprises the first connectivity information for a first remote UE.
